(19) United States
(12) Patent Application Publication
(10) Pub. No.: US 2009/0058604 A1
(43) Pub. Date: Mar. 5, 2009

(54) RFID TAG AND METHOD FOR CONTROLLING THE SAME

(75) Inventors: Jae-young JUNG, Daejeon (KR); Won Kyu CHOI, Daejeon (KR); Hae Won SON, Daejeon (KR); Hoe-Sung YANG, Daejeon (KR); Sang Yeoun LEE, Daejeon (KR); Nak Seon SEONG, Daejeon (KR); Heyung Sub LEE, Daejeon (KR); Cheol Sig PYO, Daejeon (KR)

Correspondence Address: CANTOR COLBURN, LLP, 20 Church Street, 22nd Floor, Hartford, CT, 06103, US

(73) Assignee: Electronics and Telecommunications Research Institute, Daejeon (KR)

(21) Appl. No.: 12/166,663

(22) Filed: Jul. 2, 2008

(30) Foreign Application Priority Data
Sep. 4, 2007 (KR) 10-2007-0089375

(51) Int. Cl. H04B 7/00

(52) U.S. Cl. 340/10.1

(57) ABSTRACT

Disclosed are a Radio Frequency Identification (RFID) tag and a method for controlling the same which may receive/transmit data from/to an RFID reader even at a relatively long distance. The RFID tag includes a modulation unit for modulating data requested from an RFID reader to generate a first transmission signal including the modulated data, a transmission amplification unit for amplifying the generated first transmission signal to output a second transmission signal, and a transmission antenna unit for transmitting the outputted second transmission signal to the RFID reader.

### CROSS-REFERENCE TO RELATED APPLICATION

This application claims the benefit of Korean Patent Application No. 10-2007-0089375, filed on Sep. 4, 2007, in the Korean Intellectual Property Office, the entire disclosure of which is incorporated herein by reference.

### BACKGROUND OF THE INVENTION

1. Field of the Invention

The present invention relates to a Radio Frequency Identification (RFID) tag and a method for controlling the same which may receive/transmit data from/to an RFID reader even at a relatively long distance.

This work was supported by the IT R&D program of MIC/IITA. [2005-S-106-03, Development of Sensor Tag and Sensor Node Technologies for RFID/USN]

2. Description of Related Art

In general, a Radio Frequency Identification (RFID) technology may refer to a technology which may recognize a unique identification of a tagged object via a radio signal to collect, store, process, and trace corresponding information, thereby providing services such as location determination, remote processing, management, information exchange between the tagged objects, and the like with respect to the tagged object. The RFID technology may be applicable to a variety of fields such as materials management, distribution, security, and the like by replacing the existing bar code, so that a new market is expected to be formed.

FIG. 1 is a block diagram illustrating a conventional RFID tag. Referring to FIG. 1, the conventional RFID tag includes a Radio Frequency (RF) antenna 101, a voltage booster 102, an Electrically Erasable and Programmable Read-Only Memory (EEPROM) 103, a demodulator 104, a control unit 105, and a modulator 106.

The conventional RFID tag may drive the EEPROM 103, the demodulator 104, the control unit 105, and the modulator 106 using an output voltage of the voltage booster 102 which increases power of an electromagnetic wave received via the RF antenna 101.

However, in the case where the conventional RFID tag is located far apart from the RFID reader (for example, at least 5 miles), a voltage required for driving the EEPROM 103 and the control unit 105 may be disadvantageously difficult to be obtained. As a result, the conventional RFID tag has a problem in that data is difficult to be transmitted to the RFID reader located at a relatively long distance due to a relatively weak signal strength.

Therefore, there arises a need for an RFID tag transmitting/receiving data to/from the RFID reader even at a relatively long distance.

### SUMMARY OF THE INVENTION

An aspect of the present invention provides a Radio Frequency Identification (RFID) tag and a method for controlling the same which may amplify receiving and transmitting signals received/transmitted from/to an RFID reader, respectively, thereby enabling to receive/transmit from/to the RFID reader even at a relatively long distance.

An aspect of the present invention provides an RFID tag and a method for controlling the same which may amplify the receiving signal and the transmitting signal, thereby improving receive sensitivity at the time of transmitting/receiving of signals at a long-distance.

An aspect of the present invention provides an RFID tag and a method for controlling the same which may convert an operation mode according to presence/absence of a wake-up signal, thereby minimizing power consumption.

According to an aspect of the present invention, there is provided a Radio Frequency Identification (RFID) tag, which includes a modulation unit for modulating data requested from an RFID reader to generate a first transmission signal including the modulated data; a transmission amplification unit for amplifying the generated first transmission signal to output a second transmission signal; and a transmission antenna unit for transmitting the outputted second transmission signal to the RFID reader.

In this instance, the RFID tag may further include a wake-up determining unit for determining whether a receiving signal received from the RFID reader in response to the request includes a wake-up signal, and setting an operation mode into an active mode according to the ascertained result; and a demodulation unit for restoring a command signal from the receiving signal. In this instance, the modulation unit may modulate the data acting as a response signal with respect to the restored command signal.

Also, the RFID tag may further include a power detection unit for detecting a power value of the second transmission signal fed back to the transmission antenna unit; and a gain control unit for controlling a gain of the transmission amplification unit based on the detected power value.

Also, the modulation unit may modulate the data using a back-scattering modulation scheme.

Also, the RFID tag may further include an environmental sensing unit for sensing information about a tag peripheral environment; and a memory for storing the sensed information about the tag peripheral environment.

According to an aspect of the present invention, there is provided an RFID tag control method, which includes: receiving a receiving signal from an RFID reader; extracting data in response to the received receiving signal, modulating the extracted data, and generating a first transmission signal including the modulated data; amplifying the generated first transmission signal to output a second transmission signal; and transmitting the outputted second transmission signal to the RFID reader.

In this instance, the RFID tag control method may further include monitoring information about a tag peripheral environment; and storing the monitored information about the tag peripheral environment.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is a block diagram illustrating a conventional Radio Frequency Identification (RFID) tag;

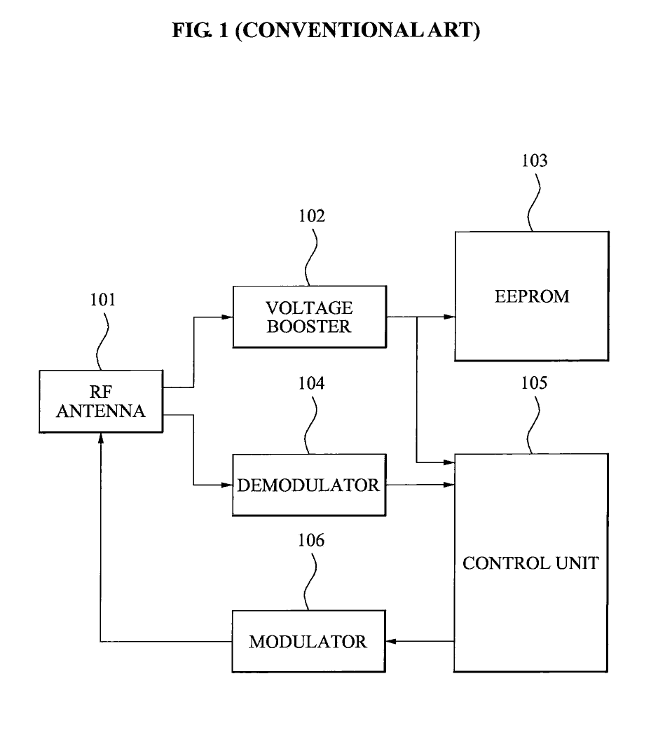

FIG. 2 is a schematic diagram illustrating an RFID system including an RFID tag according to an exemplary embodiment of the invention;

FIG. 3 is a block diagram illustrating an RFID tag according to an exemplary embodiment of the invention; and

FIG. 4 is a flowchart illustrating an RFID tag control method according to an exemplary embodiment of the invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

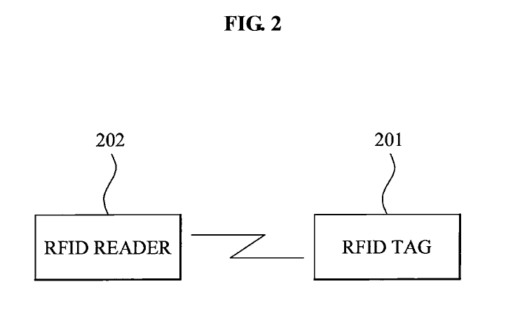

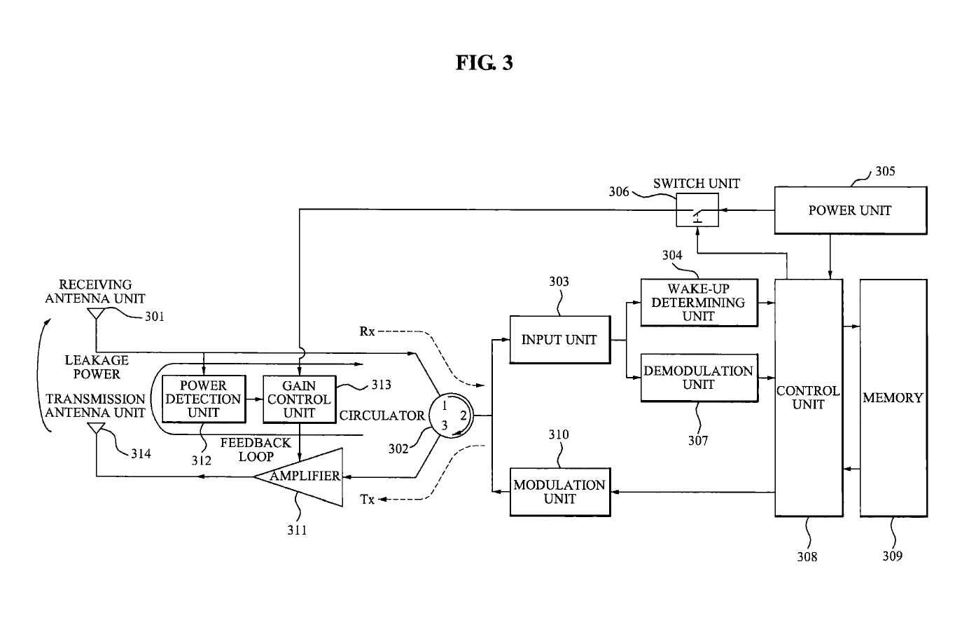

FIG. 2 is a schematic diagram illustrating an RFID system including an RFID tag according to an exemplary embodiment of the invention, and FIG. 3 is a block diagram illustrating an RFID tag 201 according to an exemplary embodiment of the invention.

Referring to FIGS. 2 and 3, the RFID tag 201 according to the present exemplary embodiment of the invention includes a receiving antenna unit 301, a circulator 302, an input unit 303, a wake-up determining unit 304, a power unit 305, a switch unit 306, a demodulation unit 307, a control unit 308, a memory 309, a modulation unit 310, an amplifier 311, a power detection unit 312, a gain control unit 313, and a transmitting antenna unit 314.

The receiving antenna unit 301 receives a receiving signal from the RFID reader 202. Here, the receiving signal may include an electromagnetic wave signal and a baseband signal. The electromagnetic wave signal may include a continuous wave (sine wave), and the baseband signal may include a wake-up signal and a command signal.

The circulator 302 receives an input of the received receiving signal, and transmits the inputted receiving signal to the input unit 303. The circulator 302 includes a plurality of ports. For example, in the case of the circulator 302 including three ports, a power inputted in a first port is transmitted to either a second port or third port located in a left and right side of the circulator 302, respectively. Specifically, the circulator 302 functions to transmit a power while having a directional property in such a manner that a signal is rotated in one direction.

Accordingly, as illustrated in FIG. 3, the circulator 302 receives an input of the receiving signal received from the first port, and outputs the received input via the second port. Also, the circulator 302 receives an input of a signal (first transmitting signal) modulated by the modulation unit 310 from the second port, and outputs the received input via the third port.

In this instance, the circulator 302 may output the receiving signal inputted via the first port to the second port. Conversely, the circulator 302 may duplicate the receiving signal inputted via the first port in the second port to thereby output the receiving signal via the third port.

The input unit 303 receives an input of the receiving signal outputted from the first port to the second port by the circulator 302, and outputs the inputted receiving signal to either the wake-up determining unit 304 or the demodulation unit 307.

The wake-up determining unit 304 receives the input of the receiving signal from the input unit 303, and determines whether the inputted receiving signal includes a wake-up signal. The wake-up determining unit 304 determines an operation mode of the RFID tag 201 into either an active mode or a sleep mode according to the determined result.

Specifically, when the receiving signal includes the wake-up signal, the wake-up determining unit 304 may determine the operation mode of the RFID tag 201 into the active mode, otherwise, the wake-up determining unit 304 may determine the operation mode of the RFID tag 201 into the sleep mode.

The wake-up determining unit 304 converts the operation mode of the RFID tag 201 into either the determined active mode or the determined sleep mode.

For example, in the case where an operation mode currently executed is the sleep mode, the wake-up determining unit 304 determines the operation mode of the RFID tag 201 into the active mode and converts the sleep mode into the determined active mode when the wake-up signal is extracted from the receiving signal.

Unlike this, the wake-up determining unit 304 determines the operation mode of the RFID tag 201 into the sleep mode, and maintains the determined sleep mode when the wake-up signal is not extracted from the receiving signal.

The power unit 305 may supply a power to internal devices (e.g., control unit, demodulation unit, modulation unit, memory, and the like) to thereby enable the internal devices to be operated, when the operation mode of the RFID tag 201 is converted into the active mode.

The switch unit 306 is switched in a state of ON to thereby supply a power to the gain control unit 313 when a high signal is transmitted from the control unit 308. As a result, the switch unit 306 may operate the gain control unit 313 to thereby control a gain of the amplifier 311.

The demodulation unit 307 demodulates the receiving signal and restores the command signal from the receiving signal when the wake-up signal is determined to be included in the receiving signal by the wake-up determining unit 304. The demodulation unit 307 demodulates the receiving signal and restores the command signal from the receiving signal when the operation mode of the RFID tag 201 is converted into the active mode by the wake-up determining unit 304.

The control unit 308 is operated when the operation mode of the RFID tag 201 is converted into the active mode by the wake-up determining unit 304. Conversely, the control unit 308 may be stopped when the operation mode of the RFID tag 201 is converted into the sleep mode by the wake-up determining unit 304. Specifically, the control unit 308 may be operated or stopped based on a signal from the wake-up determining unit 304.

For example, when the output value of the wake-up determining unit 304 is high, the control unit 308 is converted into the active mode, and supplied with a power from the power unit 305 to thereby be operated. Conversely, when the output value of the wake-up determining unit 304 is a low signal, the control unit 308 is converted into the sleep mode and the power supplied from the power unit 305 is stopped.

The control unit 308 performs the command signal to extract, from the memory 309, data (identification (ID) code or information of an object) acting as a response signal with respect to the command signal, and outputs the extracted data to the modulation unit 310.

The modulation unit 310 modulates the data to generate a first transmitting signal including the data. In this instance, the modulation unit 310 may modulate the data using a back-scattering modulation scheme. The back-scattering modulation scheme denotes a scheme in which an electromagnetic wave emitted from the RFID reader 202 is dispersed by the RFID tag 201, and a magnitude of the scattered electromagnetic wave is changed to thereby transmit information of the RFID tag 201 to the RFID reader 202.

The modulation unit 310 may switch the data to change an impedance of the RFID tag 201. In this instance, when the RFID tags 201 are match due to the change in the impedance of the RFID tag 201, the circulator 302 transmits, from the first port to the second port, an electromagnetic wave signal included in the receiving signal to thereby output the electromagnetic wave signal. Unlike this, when the RFID tags 201 does not match due to the change in the impedance of the RFID tag 201, the circulator 302 transmits the electromagnetic wave signal from the first port to the third port to thereby output the electromagnetic wave signal.

The amplifier 311 amplifies the first transmission signal to output a second transmission signal. In this instance, the amplifier 311 may synchronize the change in the impedance of the RFID tag 201 to amplify the first transmission signal, and thus outputting the second transmission signal. The amplifier 311 is operated when the operation mode is converted into the active mode by the wake-up determining unit 304. As a result, power consumption of the RFID tag 201 may be minimized.

The amplifier 311 may control an amplification gain according to an output value of the gain control unit 313 in order to remove an oscillation occurring due to leakage power fed back from the transmission antenna unit 314 to the receiving antenna unit 301, thereby amplifying the first transmission signal to output the second transmission signal.

The transmission antenna unit 314 transmits the second transmission signal to the RFID reader 202. In this instance, a part of the second transmission signal is leaked and inputted to the receiving antenna unit 301, and accordingly, an oscillation may occur due to the amplifier 311. Here, the oscillation denotes a phenomenon in which an output signal is re-inputted to acquire a gain and becomes larger when the output signal is inputted to generate a loop, and then the output signal is re-inputted to acquire a further gain and becomes gradually larger.

The power detection unit 312 detects a value of the leakage power generated when a part of signals from the transmission antenna unit 314 is leaked to the receiving antenna unit 301.

The gain control unit 313 controls a gain of the amplifier 311 based on the detected leakage power. Specifically, the gain control unit 313 controls such that a product of the value of the leakage power and a gain of the amplifier 311 is less than ‘1’, thereby removing the oscillation occurring by the amplifier 311.

In addition, although not shown, the RFID tag according to the present exemplary embodiment of the invention may further include an environmental sensing unit.

The environmental sensing unit may include a temperature sensor, a humidity sensor, a chemical sensor, and the like.

The environmental sensing unit may sense information about a tag peripheral environment, and transmit the sensed information about the tag peripheral environment to the memory 309. The memory 309 may store the transmitted information about the tag peripheral environment.

The RFID tag 201 may transmit the information about the tag peripheral environment stored in the memory 309 to the RFID reader 202.

In this manner, the RFID tag 201 may sense information about various environmental pollutants in the vicinity of the tag using the environmental sensing unit, and transmit the sensed information to the RFID reader 202.

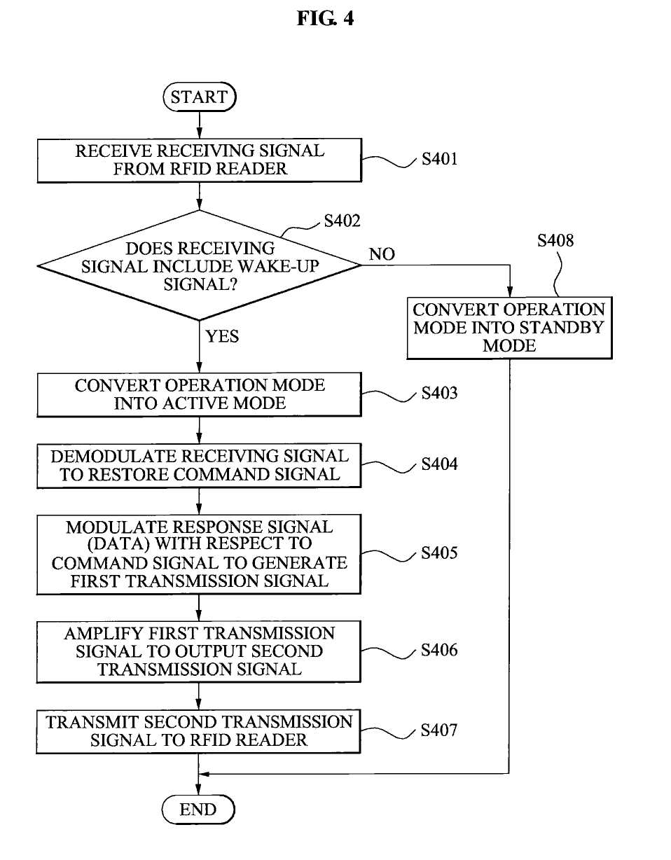

FIG. 4 is a flowchart illustrating an RFID tag control method according to an exemplary embodiment of the invention.

Referring to FIGS. 2 and 4, in operation S401, the receiving antenna unit 301 receives a receiving signal from the receiving antenna unit 301. Here, the receiving signal may include an electromagnetic wave signal and a baseband signal. The electromagnetic wave signal may include a continuous wave (sine wave), and the baseband signal may include a wake-up signal and a command signal.

In this instance, the RFID tag 201 may amplify the receiving signal using a receiving amplification unit (not shown) for amplifying the receiving signal, and output the amplified receiving signal to the circulator 302. Accordingly, the RFID tag 201 according to the present exemplary embodiment of the invention may receive a signal from the RFID reader 202 even at a relatively long distance.

Next, the circulator 302 may receive an input of the received receiving signal, and transmit the inputted receiving signal to the input unit 303. For example, the circulator 302 may receive an input of the received receiving signal via the first port to output the received input to the second port, and thus transmitting the receiving signal to the input unit 303.

Next, the input unit 303 may receive the input of the receiving signal from the circulator 302, and output the inputted receiving signal to the wake-up determining unit 304 or the demodulation unit 307.

Next, in operation S402, the wake-up determining unit 304 receives the input of the receiving signal from the input unit 303, and determines whether the inputted receiving signal includes the wake-up signal. When the inputted receiving signal includes the wake-up signal according to the determined result, the wake-up determining unit 304 converts the operation mode of the RFID tag 201 into the active mode in operation S403.

For example, in the case where a current operation mode is the sleep mode, the wake-up determining unit 304 converts the operation mode of the RFID tag 201 from the sleep mode to the active mode when the wake-up signal is extracted from the receiving signal.

In cooperation with the conversion to the active mode, the power unit 305 may supply a power to internal devices (e.g., control unit, demodulation unit, modulation unit, memory, and the like) of the RFID tag 201, thereby enabling the internal devices to be operated. Accordingly, in operation S404, the demodulation unit 307 demodulates the receiving signal and restores the command signal from the receiving signal.

Next, the control unit 308 performs the command signal to extract, from the memory 309, data (ID code or information of an object) acting as a response signal with respect to the command signal, and outputs the extracted data to the modulation unit 310.

Next, in operation S405, the modulation unit 310 modulates the data to generate a first transmission signal including the data. In this instance, the modulation unit 310 may modulate the data using a back-scattering modulation scheme. The back-scattering modulation scheme denotes a scheme in which an electromagnetic wave emitted from the RFID reader 202 is dispersed by the RFID tag 201, and a magnitude of the scattered electromagnetic wave is changed to thereby transmit information of the RFID tag 201 to the RFID reader 202.

Also, the modulation unit 310 may switch the data to change an impedance of the RFID tag 201. In this instance, when the RFID tags 201 are match due to the change in the impedance of the RFID tag 201, the circulator 302 transmits, from the first port to the second port, an electromagnetic wave signal included in the receiving signal to thereby output the electromagnetic wave signal. Unlike this, when the RFID tags 201 does not match due to the change in the impedance of the RFID tag 201, the circulator 302 transmits the electromagnetic wave signal from the first port to the third port to thereby output the electromagnetic wave signal.

Next, in operation S406, the amplifier 311 amplifies the first transmission signal to output a second transmission signal. In this instance, the amplifier 311 synchronizes the change in the impedance of the RFID tag 201 to amplify the first transmission signal, thereby outputting the second transmission signal.

Next, in operation S407, the transmission antenna unit 314 transmits the second transmission signal to the RFID reader 202. In this instance, a part of the second transmission signal may be leaked and inputted to the receiving antenna unit 301, and accordingly, an oscillation may occur due to the amplifier 311. Here, the oscillation denotes a phenomenon in which an output signal is re-inputted to acquire a gain and becomes larger when the output signal is inputted to generate a loop, and then the output signal is re-inputted to acquire a further gain and becomes gradually larger.

The oscillation may be removed by the power detection unit 312 and the gain control unit 313. Specifically, the power detection unit 312 detects a value of a leakage power generated when a part of signals from the transmission antenna unit 314 is leaked to the receiving antenna unit 301. The gain control unit 313 controls a gain of the amplifier 311 based on the detected value of the leakage power. Specifically, the gain control unit 313 controls such that a product of the value of the leakage power and the gain of the amplifier 311 is less than ‘1’, thereby removing the oscillation occurring by the amplifier 311.

When the receiving signal does not include the wake-up signal according to operation S402, the wake-up determining unit 304 converts the operation mode of the RFID tag 201 into the sleep mode in operation S408. For example, in the case where an operation mode currently performed is the sleep mode, the wake-up determining unit 304 maintains the operation mode of the RFID tag 201 to be in the sleep mode when the wake-up signal is not extracted from the receiving signal.

In addition, the RFID tag according to the present exemplary embodiment of the invention may include an environmental sensing unit including a temperature sensor, a humidity sensor, a chemical sensor, and the like. The environmental sensing unit may monitor information about the environment in the vicinity of a tag, and transmit the monitored information to the memory 309. The memory 309 may store the transmitted information about the environment in the vicinity of the tag.

The RFID tag 201 may transmit the information about the environment in the vicinity of the tag stored in the memory 309 to the RFID reader 202 when receiving, from the RFID reader 202, a request for the information about the environment in the vicinity of the tag.

In this manner, the RFID tag 201 may monitor information about various environmental pollutants in the vicinity of the tag in real time using the environmental sensing unit, and transmit the monitored information to the RFID reader 202.

The RFID tag control method according to the above-described exemplary embodiments of the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

As described above, according to the present invention, receiving and transmitting signals received/transmitted from/to an RFID reader are amplified, respectively, thereby enabling to receive/transmit from/to the RFID reader even at a relatively long distance.

According to the present invention, the receiving and transmitting signals are amplified, thereby improving receive sensitivity at the time of transmitting/receiving of signals at a long-distance.

According to the present invention, an operation mode is converted according to presence/absence of a wake-up signal, thereby minimizing power consumption.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. An Radio Frequency Identification (RFID) tag, the RFID tag comprising:
a modulation unit for modulating data requested from an RFID reader to generate a first transmission signal including the modulated data;
a transmission amplification unit for amplifying the generated first transmission signal to output a second transmission signal; and
a transmission antenna unit for transmitting the outputted second transmission signal to the RFID reader.

2. The RFID tag of claim 1, further comprising:
a wake-up determining unit for determining whether a receiving signal received from the RFID reader in response to the request includes a wake-up signal, and setting an operation mode into an active mode according to the ascertained result; and
a demodulation unit for restoring a command signal from the receiving signal,
wherein the modulation unit modulates the data acting as a response signal with respect to the restored command signal.

3. The RFID tag of claim 1, further comprising:
a power detection unit for detecting a power value of the second transmission signal fed back to the transmission antenna unit; and
a gain control unit for controlling a gain of the transmission amplification unit based on the detected power value.

4. The RFID tag of claim 1, wherein the modulation unit modulates the data using a back-scattering modulation scheme.

5. The RFID tag of claim 1, further comprising:
an environmental sensing unit for sensing information about a tag peripheral environment; and
a memory for storing the sensed information about the tag peripheral environment.

6. An RFID tag control method, comprising:
receiving a receiving signal from an RFID reader;
extracting data in response to the received receiving signal, modulating the extracted data, and generating a first transmission signal including the modulated data;
amplifying the generated first transmission signal to output a second transmission signal; and
transmitting the outputted second transmission signal to the RFID reader.

7. The RFID tag control method of claim 6, further comprising:
monitoring information about a tag peripheral environment; and
storing the monitored information about the tag peripheral environment.
